(19) United States
(12) Patent Application Publication
(10) Pub. No.: US 2017/0164646 A1
(43) Pub. Date: Jun. 15, 2017

(54) CHICKPEA FOOD COMPOSITION AND PREPARATION PROCESS

(71) Applicant: Devinder pal Singh Chahal, Vancouver (CA)

(72) Inventor: Devinder pal Singh Chahal, Vancouver (CA)

(21) Appl. No.: 14/968,469

(22) Filed: Dec. 14, 2015

(51) Int. Cl. A21D 10/00; A23L 1/30

(52) U.S. Cl. CPC A23L 11/05; A23L 29/20; A23L 5/41; A23V 2002/00

(57) ABSTRACT

Disclosed herein is a chickpea flour-based composition, comprising: a) chickpea flour; b) butter, oil or shortening; c) sugar or a sweetener; d) maple syrup; d) one or more flavoring agents; and e) one or more varieties of nuts and a process for preparing a chickpea flour-based composition.

### FIELD OF THE INVENTION

The present disclosure is in the field of chickpea snack and cereal compositions and processes to prepare the same.

### BACKGROUND OF THE DISCLOSURE

Chickpeas are rich in amino acids, protein, dietary fiber, calcium, potassium, zinc and other trace elements and other nutrients. Chickpea protein content is between about 14.9% to about 24.6%, and the fat content is about 6.4%. The majority of the fat content is in the form of unsaturated fatty acids that are beneficial to human beings. It is also shown that chickpea contains 3 times more amino acids as oat, and all 8 kinds of indispensable amino acids to humans are found in chickpeas. Linoleic acid content is about 20% more than of soybeans. Moreover, the trace element levels of iron, zinc, calcium, phosphor, etc. found in chickpeas are all higher than those found in other beans.

Therefore, there is a need for a chickpea based snack and/or cereal composition and a corresponding process to prepare that affords the nutritional benefits found in chickpeas.

### SUMMARY OF THE INVENTION

A chickpea flour-based composition, comprising: a) chickpea flour; b) butter, oil or shortening; c) sugar or a sweetener; d) maple syrup; d) one or more flavoring agents; and e) one or more varieties of nuts.

A process for preparing a chickpea flour-based composition, comprising the steps of: a) heating butter, oil or shortening; b) mixing chickpea flour with the heated butter, oil or shortening of step a) and continue heating with constant mixing; c) separately heating and caramelizing granulated white sugar or brown sugar to a chewy, firm or crunchy consistency; d) mixing maple syrup with the caramelize sugar of step c) and continue heating; e) mixing the mixture of step b) with the caramelize sugar of step c) and continue heating; f) mixing one or more varieties of nuts with the mixture of step e) or step b) and continue heating; and g) forming and cutting the mixture of step f) into a variety of shapes while the mixture is at an elevated temperature.

### DETAILED DESCRIPTION OF THE EMBODIMENTS

The following is a detailed description of certain specific embodiments of the chickpea flour-based composition and preparation process disclosed herein.

### DEFINITIONS

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. As used herein, the term “comprising” means including elements or steps that are identified following that term, but any such elements or steps are not exhaustive, and an embodiment can include other elements or steps.

The phrase “a shape that is consistent with a breakfast cereal” refers to any possible kind of cereal in piece form such as rolled cereals, gun puffed grains, cereal flakes and/or cooked-extruded cereals.

The term “food shape” refers to a food product having a shape which can be eaten by hand, no limit being set as to the choice of the shape which can be for example, a flat square bar, a flat rectangular bar, a flat circle or a cube, as well as a stick, a ball, a heart, a star, an animal shape, etc.

### INTRODUCTION

In one aspect, disclosed herein is a chickpea flour-based composition comprising: a) between about 25% to about 35% of the chickpea flour by weight; b) between about 10% to about 22% of the butter, oil or shortening by weight; c) between about 5% to about 15% of the sugar or a sweetener by weight; d) between about 2% to about 8% of the maple syrup; e) between about 1% to about 6% of the one or more flavoring agents; and f) between about 25% to about 35% of the one or more varieties of nuts by weight, wherein the total percent by weight is equal to 100%.

The sweeteners can be natural or artificial sweeteners including brown sugar, honey, sugars including sucrose, dextrose, fructose, and maltose, barley malt, high fructose corn syrup, corn syrup solids, sucralose, aspartame, saccharin, cyclamates, stevia, and the like. In some embodiments, the chickpea flour-based composition comprises between about 0% to about 30% by weight of sweetener. In some embodiments, the chickpea flour-based composition comprises between about 0.05% to about 30% by weight of sweetener. In some embodiments, the chickpea flour-based composition comprises between about 20% to about 30% by weight of sweetener. In some embodiments, the chickpea flour-based composition comprises between about 10% to about 20% by weight of sweetener. In some embodiments, the chickpea flour-based composition comprises between about 0.05% to about 10% by weight of sweetener.

In some embodiments, the chickpea flour-based composition comprises: a) between about 29% to about 31% of the chickpea flour by weight; b) between about 14% to about 18% of the butter, oil or shortening by weight; c) between about 8% to about 12% of a granulated white sugar or brown sugar by weight; d) between about 4% to about 7% of the maple syrup; e) between about 2% to about 5% of the one or more flavoring agents; and f) between about 29% to about 31% of the one or more varieties of nuts by weight, wherein the total percent by weight is equal to 100%.

The chickpea flour-based composition of the disclosure herein may include natural and/or artificial flavoring agents. Examples of natural flavoring agents include salt, vanilla, spices such as cinnamon, allspice, cloves, ginger, cassia, coca, chocolate, maple syrup, and dried fruit powders, or any other natural flavor as defined by the Code of Federal Regulations Title 21, Chapter I, Subchapter B, Section 101.22. Examples of artificial flavoring agents include maple flavor, butterscotch, vanilla, chocolate, or any other artificial flavor as defined by the Code of Federal Regulations Title 21, Chapter I, Subchapter B, Section 101.22. In some embodiments, the chickpea flour-based composition comprises between about 0.05% to about 6% by weight of flavoring agent. In some embodiments, the chickpea flour-based composition comprises between about 0.05% to about 3% by weight of flavoring agent. In some embodiments, the chickpea flour-based composition comprises between about 0.1% to about 2% by weight of flavoring agent. In some embodiments, the chickpea flour-based composition comprises between about 0.05% to about 2% by weight of salt.

In some embodiments, the chickpea flour-based composition comprises: 500 ml of chickpea flour; 300 ml of shortening; 300 ml of granulated white sugar or brown sugar; 200 ml of maple syrup; and 500 ml of one or more varieties of nuts.

In some embodiments, the chickpea flour-based composition comprises: 500 ml of chickpea flour; 300 ml of butter; 300 ml of granulated white sugar or brown sugar; 200 ml of maple syrup; and 500 ml of one or more varieties of nuts.

In some embodiments, the chickpea flour-based composition comprises: 500 ml of chickpea flour; 300 ml of oil; 300 ml of granulated white sugar or brown sugar; 200 ml of maple syrup; and 500 ml of one or more varieties of nuts.

The chickpea flour-based composition may comprise one or more fiber additives, vitamins, minerals, sweeteners, preservatives, colorants, thickeners, and/or flavoring agents. In some embodiments, the chickpea flour-based composition comprises a fiber additive, a preservative, one or more supplemental vitamins, one or more supplemental minerals, a thickener or a colorant. Examples of fiber additives include oat bran, oat fiber, oat flour, flaxseed, wheat germ, wheat bran, carboxymethyl cellulose, and the like. In some embodiments, the chickpea flour-based composition comprises between about 0% to about 30% by weight of fiber additive. In some embodiments, the chickpea flour-based composition comprises between about 10% to about 30% by weight of fiber additive. In some embodiments, the chickpea flour-based composition comprises between about 0.05% to about 10% by weight of fiber additive. In some embodiments, the chickpea flour-based composition comprises between about 0.05% to about 5% by weight of fiber additive.

Preservatives include tocopherols, ascorbic acid, butylated hydroxyanisole (BHA), butylated hydroxytoluene (BHT), and the like. In some embodiments, the chickpea flour-based composition comprises about 0 ppm to about 50 ppm of preservative.

The compositions of the disclosure can be supplemented or fortified with vitamins and minerals. Examples of vitamins include vitamin A, vitamin B₅, vitamin B₆, vitamin B₁₂, vitamin C, biotin, folate, niacin, riboflavin, thiamine, and tocopherols. In some embodiments, the chickpea flour-based composition comprises between about 0.05% to about 1% by weight of supplemental vitamins. In some embodiments, the chickpea flour-based composition comprises between about 0.05% to about 1% supplemental vitamins by weight and/or about 1% supplemental minerals by weight.

Examples of thickeners include guar gum, starch, xanthan gum, carboxymethylcellulose, gum acacia, and defatted flaxseed meal. In some embodiments, the chickpea flour-based composition comprises about between 0.05% to about 2% thickener by weight.

Examples of colorants include caramel coloring, FD&C colorings such as blue no. 1, blue no. 2, green no. 3, red no. 3, red no. 40, yellow no. 5, and yellow no. 6, and natural colors such as beta-carotenes, anthrocyanins, annatto, chlorophyllin, cochineal, betanin, curcuminoids, and carotenoids. In some embodiments, the chickpea flour-based composition comprises about 0.01% to about 5% colorant by weight. In some embodiments, the chickpea flour-based composition comprises between about 0% to about 2% by weight of colorants. In some embodiments, the chickpea flour-based composition comprises between about 0.01% to about 2% by weight of colorants. In some embodiments, the chickpea flour-based composition comprises between about 0.01% to about 1% by weight of colorants. In some embodiments, the chickpea flour-based composition comprises between about 0.01% to about 0.1% by weight of colorants.

In some embodiments, the chickpea flour-based composition comprises cashews, almonds, pistachios, peanuts, pecans and/or sunflower seeds.

In some embodiments, the chickpea flour-based composition comprises about 3% calcium by weight, preferably in form of calcium carbonate.

In some embodiments, the chickpea flour-based composition comprises humectants and/or emulsifiers. In some embodiments, the humectants may be glycerol and/or sorbitol. In some embodiments, the emulsifier may be one or more mono- or di-glycerides of consumable fatty acids, preferably derived from a vegetable, or lecithin.

In some embodiments, the chickpea flour-based composition comprises artificial antioxidants, such as tocopherols, BHA, BHT and combinations thereof.

In another aspect, disclosed herein is a process for preparing a chickpea flour-based composition, comprising the steps of: a) heating butter, oil or shortening; b) mixing chickpea flour with the heated butter, oil or shortening of step a) and continue heating with constant mixing; c) separately heating and caramelizing granulated white sugar or brown sugar to a chewy, firm or crunchy consistency; d) mixing maple syrup with the caramelize sugar of step c) and continue heating; e) mixing the mixture of step b) with the caramelize sugar of step c) and continue heating; f) mixing one or more varieties of nuts with the mixture of step e) or step b) and continue heating; and g) forming and cutting the mixture of step f) into a variety of shapes while the mixture is at an elevated temperature.

The process for preparing a chickpea flour-based composition disclosed herein pertains to a chickpea breakfast cereal, snack or food bar preparation process uses a preheated butter, oil or any other type of shortening which is combined with chickpea flour. In some embodiment, the heating is performed over an open flame with a pan or kettle at an elevated temperature. In some embodiments, the heating is performed by baking in an oven at an elevated temperature. While heating the chickpea flour the heating should continue in order to remove or reduce the nutty taste with constant mixing to avoid burning and/or a burnt smell to the heated combination of the butter, oil or any other type of shortening and the chickpea flour. Then, separately caramelize the granulated sugar white or brown sugar until it reaches a sticky consistency. Maple syrup may be added to the caramelized sugar in order to enhance a chewy consistency or cooked to achieve a firm or crunchy consistency. Further caramelizing can be used to afford a crunchy consistency for cereal or cookies as examples. Flavoring agents may be added at this stage. Raw nuts can be added to the mixture of butter, oil or any other type of shortening and the chickpea flour. Alternatively, the nuts may be added to the mixture of butter, oil or any other type of shortening and the chickpea flour, which is mixed with the caramelized sugar to form the product. The nuts may be crushed or whole. At this stage the product is formed and cut into the desired shape(s) while the mixture is still at an elevated temperature from the heating. The shapes may be garnished with nuts, fruit pieces, chocolate pieces, etc. While preservatives are not required they may be added for increased shelf life. Chips and crackers may be prepared from the composition comprising a crunchy consistency and coated with salt or additional flavoring agents. Moreover, cereal may be prepared from the mixture by cutting breakfast cereal pieces or otherwise similar to a cornflake and deep-fried. Then, the cereal pieces could be dipped into sweetener and/or one or more flavoring agents.

In some embodiments, the process for preparing a chickpea flour-based composition of step a) comprises heating to between about 100° C. to 185° C.

In some embodiments, the process for preparing a chickpea flour-based composition of step c) comprises caramelizing granulated white sugar or brown sugar to a chewy, firm or crunchy consistency.

In some embodiments, the process for preparing a chickpea flour-based composition of step f) comprises mixing the one or more varieties of roasted nuts that are crushed prior to mixing with the mixture of step e).

In some embodiments, the process for preparing a chickpea flour-based composition of step f) comprises mixing the one or more varieties of raw nuts with the mixture of step b).

In some embodiments, the process for preparing a chickpea flour-based composition of step g) further comprises that the shape is selected from a food shape selected from a flat square bar, a flat rectangular bar, a flat circle or a cube.

In some embodiments, the process for preparing a chickpea flour-based composition comprises coating the shapes with a flavoring agent.

In some embodiments, the process for preparing a chickpea flour-based composition of step g) further comprises that the shape is consistent with a breakfast cereal, wherein the breakfast cereal is deep fried and coated with a flavoring agent.

### Shaping the Chickpea Flour-Based Composition Product

Forming and cutting the chickpea flour-based composition may be performed after preparing the mixture and while still at an elevated temperature into a A variety of shapes may be cut while the product is at an elevated temperature. The heated product obtained can be formed into a bar shape by sheet-cutting, sheet-moulding, moulding or pressing through an opening and cutting. The ready-to-eat chickpea flour-based composition product may then be coated with a flavoring agent, sweet coating or nuts, etc. Moreover, the formed and/or cut shape may be consistent with a breakfast cereal flake, wherein the breakfast cereal is deep fried and coated with a flavoring agent.

The ready-to-eat chickpea flour-based composition may be conditioned in a packing providing for its protection against humidity, such as a packing made of a film with aluminum foil, or a metalized foil.

### Example 1

The ready-to-eat chickpea flour-based composition disclosed herein is prepared by heating about 300 ml of butter, oil or shortening to between about 100° C. to 185° C. Then to the heated butter, oil or shortening add about 500 ml of chickpea flour and continue heating with constant mixing. Separately heat and caramelizing granulated white sugar or brown sugar to between about 100° C. to 185° C. to form a chewy, firm or crunchy consistency. Then add about 200 ml of maple syrup with mixing to the caramelize sugar and continue heating. After the desired consistency is achieved with the caramelizing step, then add the heated chickpea flour and butter, oil or shortening to the caramelized sugar. Next, while still at an elevated temperature add about 500 ml of one or more varieties of nuts. Alternatively, the raw nuts may be added to the heated butter, oil or shortening add about 500 ml of chickpea flour and continue heating with constant mixing. Finally, forming and cutting the final mixture into a variety of shapes is performed while the mixture is at an elevated temperature. The shapes may be garnished with nuts, fruit pieces, chocolate pieces, etc.

While certain embodiments have been illustrated and described, it should be understood that changes and modifications can be made therein in accordance with ordinary skill in the art without departing from the technology in its broader aspects as defined in the following claims.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or compositions, which can of course vary. It is also to be understood that the terminology used herein is for the purpose of describing particular embodiments only, and is not intended to be limiting.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

What is claimed is:

1. A chickpea flour-based composition, comprising: a) chickpea flour; b) butter, oil or shortening; c) sugar or a sweetener; d) maple syrup; d) one or more flavoring agents; and e) one or more varieties of nuts.

2. The chickpea flour-based composition of claim 1, comprising:
a) between about 25% to about 35% of the chickpea flour by weight;
b) between about 10% to about 22% of the butter, oil or shortening by weight;
c) between about 5% to about 15% of the sugar or a sweetener by weight;
d) between about 2% to about 8% of the maple syrup;
e) between about 1% to about 6% of the one or more flavoring agents; and
f) between about 25% to about 35% of the one or more varieties of nuts by weight, wherein the total percent by weight is equal to 100%.

3. The chickpea flour-based composition of claim 1, comprising:
a) between about 29% to about 31% of the chickpea flour by weight;
b) between about 14% to about 18% of the butter, oil or shortening by weight;
c) between about 8% to about 12% of a granulated white sugar or brown sugar by weight;
d) between about 4% to about 7% of the maple syrup;
e) between about 2% to about 5% of the one or more flavoring agents; and
f) between about 29% to about 31% of the one or more varieties of nuts by weight, wherein the total percent by weight is equal to 100%.

4. The chickpea flour-based composition of claim 1, comprises 500 ml of chickpea flour; 300 ml of shortening; 300 ml of granulated white sugar or brown sugar; 200 ml of maple syrup; and 500 ml of one or more varieties of nuts.

5. The chickpea flour-based composition of claim 1, comprises 500 ml of chickpea flour; 300 ml of butter; 300 ml of granulated white sugar or brown sugar; 200 ml of maple syrup; and 500 ml of one or more varieties of nuts.

6. The chickpea flour-based composition of claim 1, comprises 500 ml of chickpea flour; 300 ml of oil; 300 ml of granulated white sugar or brown sugar; 200 ml of maple syrup; and 500 ml of one or more varieties of nuts.

7. The chickpea flour-based composition of claim 1, further comprising a fiber additive, a preservative, one or more supplemental vitamins, one or more supplemental minerals, a thickener or a colorant.

8. The chickpea flour-based composition of claim 1, comprises between about 0% to about 30% fiber additive by weight.

9. The chickpea flour-based composition of claim 1, comprises between about 0 ppm to about 50 ppm of preservative.

10. The chickpea flour-based composition of claim 1, comprises between about 0.05% to about 1% supplemental vitamins by weight and/or between about 1% supplemental minerals by weight.

11. The chickpea flour-based composition of claim 1, comprises between about 0.05% to about 2% thickener by weight.

12. The chickpea flour-based composition of claim 1, comprises between about 0.01% to about 5% colorant by weight.

13. A process for preparing a chickpea flour-based composition, comprising the steps of:
a) heating butter, oil or shortening;
b) mixing chickpea flour with the heated butter, oil or shortening of step a) and continue heating with constant mixing;
c) separately heating and caramelizing granulated white sugar or brown sugar to a chewy, firm or crunchy consistency;
d) mixing maple syrup with the caramelize sugar of step c) and continue heating;
e) mixing the mixture of step b) with the caramelize sugar of step c) and continue heating;
f) mixing one or more varieties of nuts with the mixture of step e) or step b) and continue heating; and
g) forming and cutting the mixture of step f) into a variety of shapes while the mixture is at an elevated temperature.

14. The process of claim 13, wherein step a) comprises heating to between about 100° C. to 185° C.

15. The process of claim 13, wherein step c) comprises caramelizing granulated white sugar or brown sugar to a chewy, firm or crunchy consistency.

16. The process of claim 13, wherein step f) further comprises mixing the one or more varieties of roasted nuts that are crushed prior to mixing with the mixture of step e).

17. The process of claim 13, wherein step f) further comprises mixing the one or more varieties of raw nuts with the mixture of step b).

18. The process of claim 13, wherein the step g) further comprising that the shape is selected from a food shape selected from a flat square bar, a flat rectangular bar, a flat circle or a cube.

19. The process of claim 13, further comprising coating the shapes with a flavoring agent.

20. The process of claim 13, wherein the step g) further comprises that the shape is consistent with a breakfast cereal, wherein the breakfast cereal is deep fried and coated with a flavoring agent.
